(19) United States
(12) Patent Application Publication
(10) Pub. No.: US 2017/0161453 A1
(43) Pub. Date: Jun. 8, 2017

(54) SYSTEM FOR ASTHMA EVENT DETECTION AND NOTIFICATION

(71) Applicant: Cardiac Pacemakers, Inc., St. Paul, MN (US)

(72) Inventors: Jeffrey E. Stahmann, Ramsey, MN (US); Michael J. Kane, St. Paul, MN (US); Julie A. Thompson, Circle Pines, MN (US)

(21) Appl. No.: 15/368,666

(22) Filed: Dec. 4, 2016

Related U.S. Application Data
(60) Provisional application No. 62/263,648, filed on Dec. 5, 2015.

(51) Int. Cl. G06F 19/00

(52) U.S. Cl. CPC G06F 19/3431; G06F 19/3418; G06F 19/3456

(57) ABSTRACT

A system, including a sensor configured to ambulatorily sense a parameter and a status unit configured to determine a change in asthma status of a patient based on the parameter.

### CROSS-REFERENCE TO RELATED APPLICATION

This application claims priority to Provisional Application No. 62/263,648, filed Dec. 5, 2015, which is herein incorporated by reference in its entirety.

### TECHNICAL FIELD

The present disclosure relates to early detection and treatment of health conditions and, in particular, to systems and methods for asthma event detection and notification.

### BACKGROUND

Asthma is a chronic (long-term) lung disease in which a person's airways swell and narrow and produce extra mucous. Often, this makes breathing difficult and causes chest tightness, shortness of breath, wheezing (a whistling sound when breathing), and coughing. For some people, asthma is a minor nuisance, but for others it can be a major problem that interferes with daily activities and leads to life-threatening asthma attacks.

Asthma affects people of all ages, but it most often starts during childhood. In the United States alone, more than 25 million people are known to have asthma, and about 7 million of these are children. It is estimated that the annual healthcare cost for asthma far exceeds the annual healthcare cost for heart failure.

Sometimes, asthma changes over time, such that it is important for a person with asthma to track signs and symptoms of the asthma and adjust treatment as needed. Asthma can't be cured, but it can be controlled with proper and timely treatment.

### SUMMARY

Example 1 is a system, including a sensor configured to ambulatorily sense a parameter and a status unit configured to determine a change in asthma status of a patient based on the parameter.

Example 2 is the system of Example 1, wherein the sensor has been implanted in the patient to ambulatorily sense the parameter.

Example 3 is the system of any of Examples 1 and 2, including an implantable device, wherein at least one of the sensor and the status unit is situated in the implantable device.

Example 4 is the system of any of Examples 1-3, including an external device configured to provide at least one of a display and an alarm to provide information about the change in the asthma status.

Example 5 is the system of any of Examples 1-4, including a therapy unit configured to provide asthma therapy to the patient in response to the change in the asthma status of the patient, wherein the therapy unit includes a drug delivery unit that has been implanted in the patient and is configured to provide drug therapy to the patient by at least one of automatically responding to the change of the asthma status and providing the drug therapy in response to direction from one or more of the patient and a health care provider.

Example 6 is the system of any of Examples 1-5, wherein the status unit is configured to determine the change in the asthma status by at least one of predicting an asthma exacerbation event and determining an increased risk of an asthma exacerbation event based on the parameter.

Example 7 is the system of Example 6, wherein the increased risk of the asthma exacerbation event is determined based on at least one of environmental data, patient activity, patient sleep quality, patient physical stress, patient mental stress, menstrual cycle, time-of-day, and patient posture, wherein the environmental data includes at least one of air temperature, air contaminants, humidity, altitude, and air pressure.

Example 8 is the system of any of Examples 1-7, wherein the sensor comprises at least one of a respiration sensor, a sound sensor, a heart rate sensor, an oxygen sensor, a muscle use sensor, an activity sensor, a posture sensor, an inflammation sensor, and a thoracic composition sensor.

Example 9 is the system of any of Examples 1-8, wherein the sensor includes a respiration sensor that is used to determine at least one of tidal volume, respiration rate, peak expiratory flow, forced expiratory volume, and a composite respiration index that includes at least one of an inspiration/expiration ratio, tidal volume times respiration rate, and respiration rate divided by tidal volume.

Example 10 is the system of any of Examples 1-9, wherein the sensor includes a sound sensor that includes at least one of a lung sound sensor, a speech sensor, and a heart sound sensor, wherein the lung sound sensor is configured to sense wheezing in the patient.

Example 11 is a method including sensing at least one parameter ambulatorily and determining a change in asthma status of a patient by at least one of predicting an asthma exacerbation event and determining an increased risk of an asthma exacerbation event based on the at least one parameter.

Example 12 is the method of Example 11, including at least one of creating an alert based on the change in the asthma status and releasing a drug to provide drug therapy in response to the change in the asthma status.

Example 13 is the method of Example 12, wherein releasing a drug includes at least one of releasing a rescue drug to prevent or reduce severity of the asthma exacerbation event and releasing a management drug to reduce the increased risk of having an asthma exacerbation event.

Example 14 is the method of any of Examples 12 and 13, wherein releasing a drug includes one or more of automatically releasing the drug in response to the change in the asthma status and releasing the drug after receiving permission from one or more of the patient and a health care provider.

Example 15 is the method of any of Examples 11-14, including determining if a maximum dosage of a drug has been provided to the patient and, if it has, providing at least one of alerting the patient and contacting a health care provider that the maximum dosage has been provided to the patient.

Example 16 is a system, including a sensor configured to ambulatorily sense a parameter that is one or more of predictive of an asthma exacerbation event and useful in determining an increased risk of an asthma exacerbation event for a patient and a status unit configured to determine a change in asthma status of the patient by at least one of predicting the asthma exacerbation event and determining the increased risk of the asthma exacerbation event based on the parameter.

Example 17 is the system of Example 16, wherein the sensor has been implanted in the patient to ambulatorily sense the parameter.

Example 18 is the system of Example 16, including an implantable device, wherein the sensor is situated in the implantable device.

Example 19 is the system of Example 18, wherein the status unit is situated in the implantable device.

Example 20 is the system of Example 16, including an external device, wherein the status unit is situated in the external device.

Example 21 is the system of Example 16, including an external device configured to provide at least one of a display and an alarm to provide information about the change in the asthma status.

Example 22 is the system of Example 16, including a therapy unit configured to provide asthma therapy to the patient in response to the change in the asthma status of the patient.

Example 23 is the system of Example 22, wherein the therapy unit includes a drug delivery unit that has been implanted in the patient and is configured to provide drug therapy to the patient by at least one of automatically responding to the change of the asthma status and providing the drug therapy in response to direction from one or more of the patient and a health care provider.

Example 24 is the system of Example 16, wherein the sensor is configured to sense at least one physiological parameter of the patient.

Example 25 is the system of Example 16, wherein the status unit is configured to determine the change in the asthma status of the patient by at least one of predicting that the asthma exacerbation event will occur within 3 days and determining the increased risk of the asthma exacerbation event up to 30 days prior to the asthma exacerbation event.

Example 26 is a system including at least one sensor that has been implanted in a patient to ambulatorily sense at least one physiological parameter of the patient and a status unit to determine a change in asthma status of the patient based on at least one of predicting an asthma exacerbation event based on the at least one physiological parameter and determining an increased risk of the asthma exacerbation event based on the at least one physiological parameter.

Example 26 is the system of Example 26, wherein the at least one sensor includes at least one of a respiration sensor, a sound sensor, a heart rate sensor, an oxygen sensor, a muscle use sensor, an activity sensor, a posture sensor, an inflammation sensor, and a thoracic composition sensor.

Example 28 is the system of Example 26, wherein the at least one sensor includes a respiration sensor that is used to determine at least one of tidal volume, respiration rate, peak expiratory flow, forced expiratory volume, and a composite respiration index that includes at least one of an inspiration/expiration ratio, tidal volume times respiration rate, and respiration rate divided by tidal volume.

Example 29 is the system of Example 26, wherein the at least one sensor includes a sound sensor that includes at least one of a lung sound sensor, a speech sensor, and a heart sound sensor, wherein the lung sound sensor is configured to sense wheezing in the patient.

Example 30 is the system of Example 26, wherein the increased risk of the asthma exacerbation event is determined based on at least one of environmental data, patient activity, patient sleep quality, patient physical stress, patient mental stress, menstrual cycle, time-of-day, and patient posture, wherein the environmental data includes at least one of air temperature, air contaminants, humidity, altitude, and air pressure.

Example 31 is a method including sensing, ambulatorily, at least one parameter that is one or more of predictive of an asthma exacerbation event and useful in determining an increased risk of an asthma exacerbation event for a patient and determining a change in asthma status of the patient by at least one of predicting the asthma exacerbation event and determining the increased risk of the asthma exacerbation event based on the at least one parameter.

Example 32 is the method of Example 31, including at least one of creating an alert based on the change in the asthma status and releasing a drug to provide drug therapy in response to the change in the asthma status.

Example 33 is the method of Example 32, wherein releasing a drug includes at least one of releasing a rescue drug to prevent or reduce the severity of the asthma exacerbation event and releasing a management drug to reduce the risk of having an asthma exacerbation event.

Example 34 is the method of Example 32, wherein releasing a drug includes one or more of automatically releasing the drug in response to the change in the asthma status and releasing the drug after receiving permission from one or more of the patient and a health care provider.

Example 35 is the method of Example 31, including determining if a maximum dosage of the drug has been provided to the patient and, if it has, providing at least one of alerting the patient and contacting a health care provider that the maximum dosage has already been provided to the patient.

While multiple embodiments are disclosed, still other embodiments of the disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a diagram illustrating a system for asthma event detection and notification, according to embodiments of the disclosure.

FIG. 2 is a diagram illustrating a system including an implantable device and an external device, according to embodiments of the disclosure.

FIG. 3 is a diagram illustrating a system including an implantable device, an external device, and other sources, according to embodiments of the disclosure.

FIG. 4 is a diagram illustrating a system for asthma event detection and notification and for providing therapy to an asthma patient, according to embodiments of the disclosure.

FIG. 5 is a flow chart diagram illustrating a method of determining a change in the asthma status of a patient and providing asthma therapy, according to embodiments of the disclosure.

FIG. 6 is a flow chart diagram illustrating a method for monitoring and detecting a change in the asthma status, according to embodiments of the disclosure.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

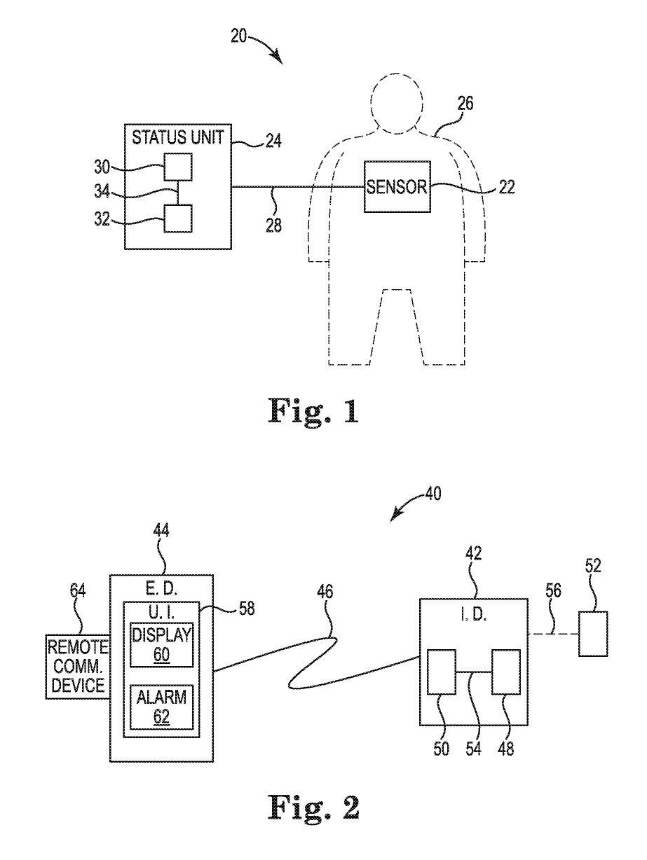

FIG. 1 is a diagram illustrating a system 20 for asthma event detection and notification, according to embodiments of the disclosure. The system 20 includes at least one sensor 22 communicatively coupled to a status unit 24. In some embodiments, the system 20 includes a plurality of sensors, such as sensor 22, which are communicatively coupled to the status unit 24.

The sensor 22 is configured to sense one or more parameters that can be used to determine a change in status of a patient's asthma, and the status unit 24 is configured to determine the change in asthma status of the patient 26 based on the one or more sensed parameters. As illustrated in FIG. 1, the sensor 22 and the status unit 24 are separate devices. In other embodiments, the sensor 22 can include the status unit 24 as part of the sensor 22, such that the status unit 24 is situated inside the sensor 22.

The sensor 22 is communicatively coupled to the status unit 24 by communications path 28. In some embodiments, the sensor 22 is hard wired to the status unit 24 and, in some embodiments, the sensor 22 communicates with the status unit 24 via wireless communication techniques, such as radio frequency (RF), inductive, conductive, and capacitive communication techniques.

The sensor 22 senses one or more parameters that can be used to determine the change in asthma status of the patient 26. In some embodiments, sensing one or more parameters includes sensing one or more parameters that are predictive, i.e., provide early detection, of an acute onset asthma exacerbation event. The asthma exacerbation event may be an event that would otherwise interfere with daily activities and/or be life-threatening. This early detection or prediction of the asthma exacerbation event can be used to alert the patient and/or a health provider to the upcoming event and to abate the event by providing therapy, including drug therapy, to the patient 26. Early detection provides an opportunity to abate the event and prevent major and very distressing patient symptoms, emergency room visits and hospitalizations, potentially life-threatening ramifications, and major healthcare costs. In some embodiments, the early detection may be up to three days before the asthma exacerbation event.

In some embodiments, sensing one or more parameters that can be used to determine the change in asthma status includes sensing one or more parameters that are predictive of an increased probability or risk of an asthma exacerbation event for the patient. Where, in some embodiments, the increased risk may be an increased risk of an asthma exacerbation event taking place within the next 30 days.

The sensor 22 can be configured to sense physiological information about the patient 26. In embodiments, the sensor 20 includes at least one of a respiration sensor, a sound sensor, a heart rate sensor, an oxygen sensor, a muscle use sensor, an activity sensor, a posture sensor, an inflammation sensor, a chemical sensor, an exhaled breath sensor, a thoracic composition sensor, an altered consciousness sensor, a central cyanosis sensor, and a sleep quality sensor.

Respiration sensors can be used to determine tidal volume (VT), respiration rate, peak expiratory flow rate (PEFR), forced expiratory volume (FEV), and a composite respiration index that includes at least one of an inspiration/expiration ratio (IER), VT times respiration rate, and respiration rate divided by VT. Respiration sensors may include any number of different types of sensors, including thoracic impedance sensors, accelerometers, flow sensors, and electrocardiograms (ECG or EKG). For example, the respiration rate can be sensed by one or more of a thoracic impedance sensor, an accelerometer, and an ECG. Also, the PEFR and the FEV can be determined using a thoracic impedance sensor to measure VT, and the IER can be determined using a thoracic impedance to measure VT. Other parameters associated with a pulmonary functional test can also be used in determining asthma status. These parameters include the VT, FEV, and PEFR parameters, minute volume (MV), vital capacity (VC), functional residual capacity (FRC), total lung capacity, forced vital capacity (FVC), and forced expiratory flow (FEF).

Sound sensors can include at least one of a lung sound sensor, a speech sensor, and a heart sound sensor, where the lung sound sensor can be configured to sense wheezing in the patient. In embodiments, sound sensors include one or more of an accelerometer and a microphone. For example, a speech sensor and a lung sound sensor for sensing wheezing can include one or more of an accelerometer and a microphone.

In embodiments, a heart rate sensor includes an ECG for measuring the heart rate, an oxygen sensor includes an optical oxygen saturation sensor, and a central cyanosis sensor includes an optical oxygen saturation sensor. Also, in embodiments, a muscle use sensor and an activity sensor include one or more of a cervical and thoracic impedance sensor and a electromyogram for measuring activity. In addition, a posture sensor and an altered consciousness sensor include an accelerometer for measuring posture and/or balance. The inflammation sensor includes a chemo sensor for detecting an inflammatory marker, such as nitric oxide, and the sleep quality sensor includes one or more of a thoracic impedance sensor, an accelerometer, and an ECG for measuring tidal volume, respiration rate activity, posture, and heart rate.

In embodiments, a chemical sensor includes one or more of an inflammatory marker, e.g., a C-reactive protein, a pharmaceutical agent, e.g., theophylline, beta blockers, and/or aspirin, a blood gas, e.g., oxygen and/or carbon dioxide, and blood cell count, e.g., an eosinophil count.

In embodiments, a breath sensor includes a nitric oxide test, where increased levels of exhaled nitric oxide indicate inflammation, which can indicate a worsening asthma status.

The status unit 24 is configured to determine the change in asthma status based on the one or more sensed parameters. In some embodiments, determining the change in status includes predicting the asthma exacerbation event and, in some embodiments, determining the change in status includes determining the increased probability or risk of the asthma exacerbation event based on the one or more parameters. Also, in some embodiments, the prediction or early detection may be up to three days before the asthma exacerbation event and, in some embodiments, the increased risk determination may be for an increased risk of an asthma exacerbation event taking place within the next 30 days.

The status unit 24 receives the one or more sensed parameters form the sensor 22 and, in some embodiments, the status unit 24 receives parameters from other sensors or devices for sensing and transmitting data to the status unit 24. For example, the increased risk of the asthma exacerbation event can be determined based on at least one of environmental data, patient activity, patient sleep quality, patient physical stress, patient mental stress, menstrual cycle, time-of-day, and patient posture. Where the environmental data includes at least one of air temperature, air contaminants, humidity, altitude, and air pressure. This environmental data can be collected or transmitted by a local external device, either on the patient 26, such as a watch, or in the home, such as a smoke detector. Also, the environmental data can be collected from public sources, such as meteorological services, or internet sites, such as airnow.gov. The status unit 24 receives the one or more parameters and other information and, in some embodiments, stores the data in memory for review and later transmission to patients, health care providers, and other users.

The status unit 24 includes an electronic circuit 30, such as a processor, a controller, a microprocessor, and/or an application specific integrated circuit, and memory 32 for storing data, such as the sensor data and other information and a software program or computer program that is executed by the electronic circuit 30 to provide functions of the system 20. The electronic circuit 30 is communicatively coupled to the memory 32 via communications path 34. In some embodiments, the system 20 includes multiple sensors, such as sensor 22, communicatively coupled to the status unit 24, such that the status unit 24 receives and utilizes many parameters to determine the change in status of the patient's asthma. In some embodiments, the system 20 includes other sources, such as local and public external sources including sources over the internet, for providing data to the status unit, such that the status unit 24 receives and utilizes many parameters and different data to determine the change in status of the patient's asthma.

In some embodiments, the sensor 22 is implanted or inserted into the patient 26, and/or configured to be worn by, or otherwise externally coupled to the patient 26 in a manner that allows the patient 26 to move about, to ambulatorily sense the one or more parameters. Ambulatorily sensing connotes implementations in which the sensor 22 is operatively coupled to the patient 26 (e.g., chronically implanted in the patient 26, worn by the patient 26, etc.). Provision of a chronically implanted or externally coupled sensor, in contrast to an acute sensing approach, allows the patient 26 to go about his or her normal routine for extended periods of time, unencumbered by catheters and/or temporary percutaneously sensing apparatuses that are used in hospital settings for conducting short-term invasive evaluations lasting on the order of hours. A chronically implanted sensor provides for an ability to perform ambulatorily sensing on the order of days, weeks, months, or even years. In this manner, embodiments of the disclosed subject matter facilitate ambulatorily monitoring a patient in a more natural context than that of a purposeful monitoring study performed in a clinical environment.

In some embodiments, the sensor 22 and the status unit 26 are implanted in the patient 24 to ambulatorily sense the one or more parameters and to ambulatorily determine the change in status of the patient's asthma. In these embodiments, the sensor 22 is communicatively coupled to the status unit 24 via at least one of a wired connection and a wireless connection, such as an RF connection. In some embodiments, the sensor 22 is implanted in the patient 26 to ambulatorily sense the one or more parameters and the status unit 24 is maintained external to the patient 26, where the sensor 22 is communicatively coupled to the status unit 24 via a wireless communication technique, such as an RF, inductive, conductive, and/or capacitive communication technique.

In some embodiments, the system 20 includes an implantable device that can be implanted in the body of the patient, with the sensor 22 and/or the status unit 24 situated in the implantable device and, in some embodiments, the system 20 includes an external device communicatively coupled to at least one of the sensor 22, the status unit 24, and an implantable device. In embodiments, the sensor 22 may refer to more than one sensing device. The sensing devices may be implanted in the patient 26, coupled externally to the patient 26, and/or a combination thereof (e.g., one or more sensing devices may be implanted and one or more other sensing devices may be coupled externally to the patient 26).

In operation, the sensor 22 senses at least one parameter that can be used for at least one of predicting an asthma exacerbation event and determining an increased risk of an asthma exacerbation event for the patient 26. The status unit 24 receives the sensed parameter(s) from the sensor 22 via communications path 28 and the electronic circuit 30 of the status unit 24 executes software code out of the memory 32 to determine a change in asthma status of the patient 26 by at least one of predicting the asthma exacerbation event based on the at least one parameter and determining the increased risk of the asthma exacerbation event based on the at least one parameter. In some embodiments, the status unit 24 stores the at least one parameter from the sensor 22 in the memory 32, such that the data can be transmitted to and reviewed by health care providers and other users.

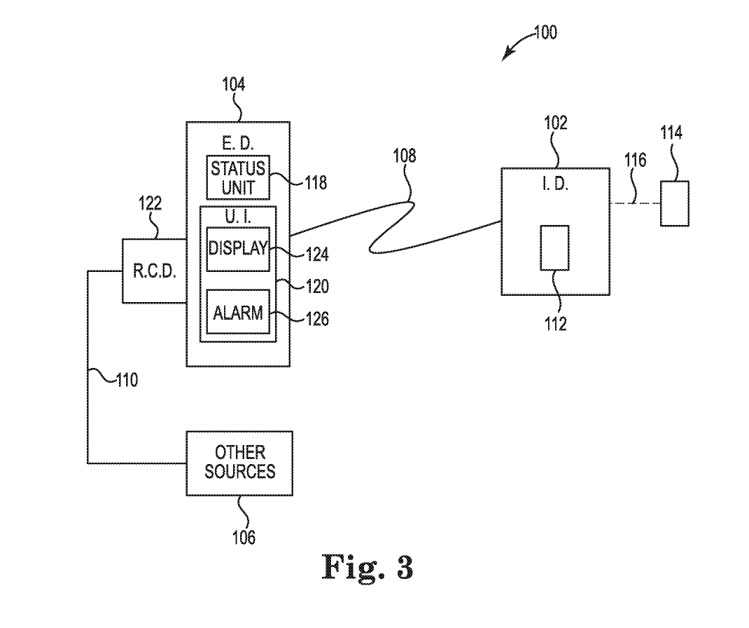

FIG. 2 is a diagram illustrating a system 40 that includes an implantable device 42 and an external device 44, according to embodiments of the disclosure. The implantable device 42 is implanted in the patient, such as patient 26, and the external device 44 is situated outside of the patient. The implantable device 42 is communicatively coupled to the external device 44 by communications path 46. The implantable device 42 communicates with the external device 44 via wireless communication techniques, such as RF, inductive, conductive, and capacitive communication techniques.

The implantable device 42 includes a sensor 48 and a status unit 50. The sensor 48 is similar to the sensor 22 (shown in FIG. 1), with the exception of being situated in the implantable device 42, and the status unit 50 is similar to the status unit 24 (shown in FIG. 1), with the exception of being situated in the implantable device 42. In some embodiments, the implantable device 42 includes a plurality of sensors, such as sensor 48, which are communicatively coupled to the status unit 50. In some embodiments, the system 40 includes one or more other sensors, such as sensor 52 situated outside the implantable device 42, where sensor 52 is similar to the sensor 22 (shown in FIG. 1). In other embodiments, the implantable device 42 does not include the sensor 48.

The sensor 48 is communicatively coupled to the status unit 50 by communications path 54. In some embodiments, the sensor 48 is hard wired to the status unit 50 and, in some embodiments, the sensor 48 communicates with the status unit 50 via wireless communication techniques, such as RF, inductive, conductive, and capacitive communication techniques. Also, in embodiments that include sensor 52, the sensor 52 is communicatively coupled to the status unit 50 by communications path 56, where in some embodiments, the sensor 52 is hard wired to the status unit 50 and, in some embodiments, the sensor 52 communicates with the status unit 50 via wireless communication techniques, such as RF, inductive, conductive, and capacitive communication techniques. In addition, in some embodiments, the status unit 50 provides communications with the external device 44 via communications path 46.

The implantable device 42 provides a protected environment for the sensor 48 and the status unit 50. The sensors 48 and 52 and the status unit 50 are similar to the sensor 22 and the status unit 24, such that the description above for the sensor 22 and the status unit 24 will not be repeated here for the sensors 48 and 52 and the status unit 50.

The external device 44 includes a user interface 58 for information input and output, which includes a display 60 and an alarm 62. The display 60 can include a touch screen for input and a visual display for displaying text and graphics. The alarm 62 can include one or more of visual alarms, such as lights, audio alarms, such as buzzers, and vibrational alarms. Also, in some embodiments, the external device 44 includes a remote communications device 64, such as an internet connection or a cell telephone, which can be used to provide information to and receive information from a health care provider or another user.

The external device 44 receives the change of asthma status information from the status unit 50 by way of the communications path 46. The external device 44 displays the asthma status information on the display 60 and alerts the patient to the change in the asthma status via the alarm 62. In some embodiments, the external device 44 displays that an asthma exacerbation event can be expected within the next three days and, in some embodiments, the external device 44 recommends a course of action, such as administering medication, moving to a less asthma-provoking environment, or calling a health care provider, to abate the onset of the asthma exacerbation event. In some embodiments, the external device 44 displays that the patient is at a higher risk of having an asthma exacerbation event within the next 30 days and, in some embodiments, the external device 44 displays the reasons for the higher risk, such as environmental data including humidity, altitude, air pressure, air temperature, and contaminants in the air and/or physiological data including activity, posture, and sleep quality of the patient.

Optionally, the external device 44 notifies a health care provider or another user to the change in the asthma status of the patient by using the remote communications device 64. In response, the health care provider or the other user can provide medical advice, such as a recommended medication and dosage, to the patient through the external device 44 by way of the remote communications device 64. This medical advice can be displayed on the display 60 and the alarm 62 activated to notify the patient that the information is available for viewing.

FIG. 3 is a diagram illustrating a system 100 including an implantable device 102, an external device 104, and other sources 106, according to embodiments of the disclosure. The implantable device 102 is implanted in the patient, such as patient 26, the external device 104 is situated outside of the patient, and the other sources 106 can be implanted in the patient and/or situated outside of the patient. The implantable device 102 is communicatively coupled to the external device 104 by communications path 108, and the other sources 106 are communicatively coupled to the external device 104 by communication paths 110. The implantable device 102 communicates with the external device 104 via wireless communication techniques, such as RF, inductive, conductive, and capacitive communication techniques. The other sources 106 communicate with the external device 104 via wired connections and/or wireless communication techniques, such as RF, inductive, conductive, and capacitive communication techniques.

The implantable device 102 includes a sensor 112. The sensor 112 is similar to the sensor 48 (shown in FIG. 2). In some embodiments, the implantable device 102 includes a plurality of sensors, such as sensor 112. In some embodiments, the system 100 includes one or more sensors, such as sensor 114, situated outside the implantable device 102, where the sensor 114 is similar to the sensor 22 (shown in FIG. 1). In some embodiments, the sensor 114 is implanted in the patient and, in some embodiments the sensor 114 is situated external to the patient. In other embodiments, the implantable device 102 does not include the sensor 112 or any sensors.

The sensor 112 is communicatively coupled to the external device 104 by communications path 108. The sensor 112 communicates with the external device 104 via wireless communication techniques, such as RF, inductive, conductive, and capacitive communication techniques. Also, in embodiments that include the sensor 114, the sensor 114 can be communicatively coupled to the implantable device 102 via communications path 116 and to the external device 104 via communications path 108. Where, in some embodiments, the sensor 114 is hard wired to the implantable device 102 and, in some embodiments, the sensor 114 communicates with the implantable device 102 via wireless communication techniques, such as RF, inductive, conductive, and capacitive communication techniques. Alternatively, the sensor 114 can be communicatively coupled directly to the external device 104, where, in some embodiments, the sensor 114 is hard wired to the external device 104 and, in some embodiments, the sensor 114 communicates with the external device 104 via wireless communication techniques, such as RF, inductive, conductive, and capacitive communication techniques.

The implantable device 102 provides a protected environment for the sensor 112 and, in some embodiments, the implantable device 102 includes communication circuits for communicating with the external device 104. The sensors 112 and 114 are similar to the sensor 22 (shown in FIG. 1), such that the description above for the sensor 22 will not be repeated here for the sensors 112 and 114.

The external device 104 includes a status unit 118, a user interface 120, and a remote communications device 122. The status unit 118 is similar to the status unit 24 (shown in FIG. 1) and similar to the status unit 50 (shown in FIG. 2), with the exception that the status unit 118 is situated in the external device 104. The status unit 118 communicates with the sensors 112 and 114 via communications path 108 or, in some embodiments, directly with the sensors 112 and 114 via wireless communication techniques, such as RF, inductive, conductive, and capacitive techniques. The status unit 118 is similar to the status unit 24 (shown in FIG. 1), such that the description above for the status unit 24 will not be repeated here for the status unit 118.

The user interface 120 is for information input and output. The user interface 120 includes a display 124 and an alarm 126. The display 124 includes a touch screen for input and a visual display for displaying text and graphics. The alarm 126 includes one or more of visual alarms, such as lights, audio alarms, such as buzzers, and vibrational alarms.

The remote communications device 122 is configured to communicate with the other sources 106 and with users, such as a health care provider and other users for providing information to and receiving information from the health care provider and the other users. The remote communications device 122 is communicatively coupled to the other sources 106 via communication paths 110. In some embodiments, the remote communications device 122 includes internet connectivity and/or cell telephone capability for communicating with the other sources 106 and/or the health care provider and other users. In some embodiments, the remote communications device 122 communicates with the other sources 106 and/or the health care provider and other users via wired connections and, in some embodiments, the remote communications device 122 communicates with the other sources 106 and/or the health care provider and other users via wireless communication techniques, such as RF, inductive, conductive, and capacitive techniques.

The other sources 106 include devices or systems for providing data to the status unit 118 for determining the change in asthma status of the patient. For example, the other sources 106 may include local external devices, such as a home air quality monitor, e.g., a smoke detector, an activity monitor worn by the patient or situated in the home, a respiration monitor worn by the patient or situated in the home, a cardiac monitor worn by the patient or situated in the home, a sleep quality monitor worn by the patient or situated in the home, a stress monitor worn by the patient or situated in the home, a wrist watch for providing the time of day, a smart telephone, and a posture monitor worn by the patient or situated in the home. Also, the other sources 106 may include public sources, such as meteorological services and/or internet sites, such as airnow.gov, for providing data, such as environmental data including air temperature, air contaminants, humidity, altitude, and air pressure.

The status unit 118 receives the parameters form the sensors 112 and 114 and the data from the other sources 106 and determines the change of asthma status for the patient. The external device 104 displays the asthma status information on the display 124 and alerts the patient to the change in the asthma status via the alarm 126. In some embodiments, the external device 104 displays that an asthma exacerbation event can be expected within the next three days and, in some embodiments, the external device 104 recommends a course of action, such as administering medication or calling a health care provider, to abate the onset of the asthma exacerbation event. In some embodiments, the external device 104 displays that the patient is at a higher risk of having an asthma exacerbation event within the next 30 days and, in some embodiments, the external device 104 displays the reasons for the higher risk, such as environmental data including humidity, altitude, air pressure, air temperature, and contaminants in the air and/or physiological data including activity, posture, and sleep quality of the patient.

In embodiments, the external device 104 notifies a health care provider or another user to the change in the asthma status of the patient by using the remote communications device 122. In response, the health care provider or the other user can provide medical advice, such as a recommended medication and dosage, to the patient through the external device 104 by way of the remote communications device 122 or the health care provider can recommend that the patient come into the health care provider's office. This medical advice can be displayed on the display 124 and the alarm 126 activated to notify the patient that the information is available for viewing.

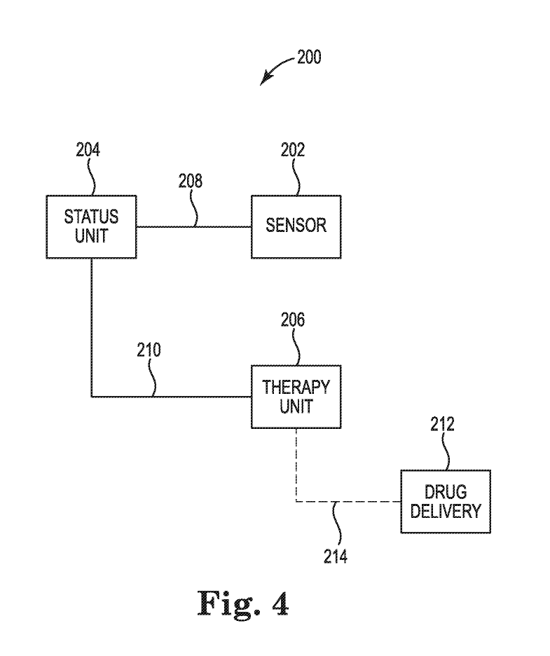

FIG. 4 is a diagram illustrating a system 200 for asthma event detection and notification and for providing therapy, such as drug therapy, to an asthma patient, according to embodiments of the disclosure. The system 200 includes at least one sensor 202, a status unit 204, and a therapy unit 206. The sensor 202 is communicatively coupled to the status unit 204 via communications path 208, and the status unit 204 is communicatively coupled to the therapy unit 206 via communications path 210. In some embodiments, the system 200 includes a plurality of sensors, such as sensor 202, which are communicatively coupled to the status unit 204. Also, in embodiments, the system 200 can be similar to any of the systems previously described in the disclosure, such as system 20 of FIG. 1, system 40 of FIG. 2, and system 100 of FIG. 3, with the exception that the system 200 includes the therapy unit 206.

The sensor 202 is configured to sense one or more parameters that can be used to determine a change in status of a patient's asthma, and the status unit 204 is configured to determine the change in asthma status of a patient based on the one or more sensed parameters. As illustrated, the sensor 202 and the status unit 204 are separate devices. In other embodiments, the sensor 202 can include the status unit 204 as part of the sensor 202, such that the status unit 204 is situated inside the sensor 202.

The sensor 202 can be any of implanted in the patient, situated outside the patient, and situated inside or outside an implantable device, such as implantable device 42 (shown in FIG. 2) and implantable device 102 (shown in FIG. 3). The status unit 204, can be any of implanted in the patient, situated outside the patient, situated inside or outside an implantable device, such as implantable device 42 (shown in FIG. 2) and implantable device 102 (shown in FIG. 3), and situated inside or outside an external device, such as external device 44 (shown in FIG. 2) and external device 104 (shown in FIG. 3). The sensor 202 is similar to the sensor 22 (shown in FIG. 1) and the status unit 204 is similar to the status unit 24 (shown in FIG. 1), such that the description of sensor 22 and status unit 24 will not be repeated here for the sensor 202 and the status unit 204.

The therapy unit 206 is configured to provide asthma therapy to the patient based on the change in the asthma status of the patient. The therapy unit 206 can be any of implanted in the patient, situated outside the patient, situated inside or outside an implantable device, such as implantable device 42 (shown in FIG. 2) and implantable device 102 (shown in FIG. 3), and situated inside or outside an external device, such as external device 44 (shown in FIG. 2) and external device 104 (shown in FIG. 3).

In some embodiments, the therapy unit 206 is configured to provide drug therapy to the patient and includes a drug delivery unit 212 communicatively coupled to the therapy unit 206 via communications path 214. The drug delivery unit 212 can be any of implanted in the patient, situated outside the patient, situated inside or outside an implantable device, such as implantable device 42 (shown in FIG. 2) and implantable device 102 (shown in FIG. 3), and situated inside or outside an external device, such as external device 44 (shown in FIG. 2) and external device 104 (shown in FIG. 3). In some embodiments, the therapy unit 206 communicates with the drug delivery unit 212 via a wired connection and, in some embodiments, the therapy unit 206 communicates with the drug delivery unit 212 via a wireless technique, such as RF, inductive, conductive, and capacitive techniques.

The therapy unit 206 receives information from the status unit 204 for providing asthma therapy to the patient. In some embodiments, the therapy unit 206 receives information about a change in the asthma status of the patient and in response to this information the therapy unit 206 automatically provides therapy to the patient. In some embodiments, the therapy unit 206 automatically provides therapy to the patient by directing the drug delivery unit 212 to administer drugs, such as epinephrine and methylprednisolone, to the patient to treat the declared event.

In some embodiments, the status unit 204 determines the change in the asthma status of the patient and the status unit 204 alerts the patient and/or a health care provider to the change in the asthma status. For example, the status unit 206 can display the information on a display for the patient and send a message via a remote communications device, such as the remote communications device 64 (shown in FIG. 2) or the remote communications device 122 (shown in FIG. 3) to the health care provider. The patient and/or the health care provider can respond to the message by giving or withholding consent to provide the drug therapy. If consent is given, the status unit 204 directs the therapy unit 206 to provide therapy, where the therapy unit 206 directs the drug delivery unit 212 to administer drugs, such as epinephrine and methylprednisolone, to the patient to treat the declared event. In addition, multiple doses and/or multiple drugs are possible. In some embodiments, the patient and/or the health care provider can prescribe a certain dosage and/or a certain kind of medication, such that the dose is delivered per patient or health care provider prescription.

In some embodiments, the status unit 204 or the therapy unit 206 can check to see if the patient has already received a maximum dosage of a drug and, if the patient has, the system 200 can alert the patient and/or the health care provider. In some embodiments, the status unit 204 monitors the patient's parameters, such as heart rate, oxygen saturation, and/or respiration rate, to determine if the patient exhibits a contraindication to receiving therapy. If a contraindication Is exhibited, the status unit 204 and the therapy unit 206 alert the patient and/or the health care provider to the problem and refrain from administering the drug, unless further directed to do so by the patient and/or the health care provider.

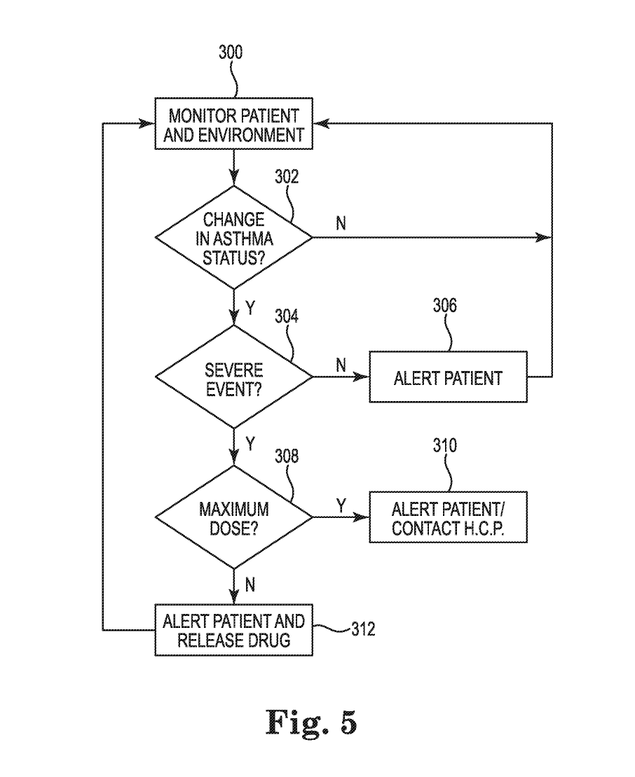

FIG. 5 is a flow chart diagram illustrating a method of determining a change in the asthma status of a patient and providing asthma therapy, according to embodiments of the disclosure. At 300, a system, such as one of the systems described above, is used to monitor the patient and the environment. For example, one or more of the sensors, such as sensor 22 (shown in FIG. 1), are implanted in the asthma patient for ambulatorily sensing one or more patient parameters, and one or more other sensors are situated outside the patient for sensing one or more patient patients or other parameters, such as environmental parameters. In addition, other sources, such as the other sources 106 (shown in FIG. 3), are used to provide data, including patient data and other data, such as environmental data. The status unit of the system, such as status unit 24 (shown in FIG. 1), receives the sensed parameters and the data from the sensors and the other sources.

At 302, using this received information, the status unit determines whether a change in the asthma status of the patient has taken place. The status unit determines a change in the asthma status by one or more of predicting an asthma exacerbation event, such acute onset of an asthma attack within three days, and determining an increased risk of an asthma exacerbation event based on the at least one parameter, such as determining an increased risk of an asthma exacerbation event within the next 30 days.

In one example, the status unit receives parameters and data including oxygen saturation, inhalation-exhalation ratio, accessory muscle use, wheezing, heart rate, and respiratory rate. Using this information, the status unit determines a change in asthma status by predicting whether the patient can expect an asthma exacerbation event within the next three days.

In another example, the status unit receives parameters and data including information about altered consciousness, speaking ability, such as speaking in sentences, phrases, words, or unable to speak, heart rate, and wheezing. Using this information, the status unit determines a change in asthma status by predicting whether the patient can expect an asthma exacerbation event within the next three days.

In another example, the status unit receives parameters and data including air contaminant data, air temperature, humidity, altitude, and air pressure and other data including patient activity, posture, and sleep quality data. Using this information, the status unit determines a change in asthma status by determining an increased risk of an asthma exacerbation event, such as by determining an increased risk of an asthma exacerbation event within the next 30 days.

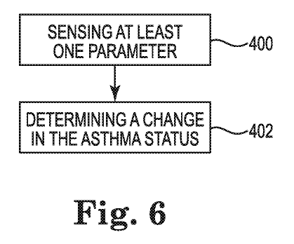

FIG. 6 is a flow chart diagram illustrating a method for monitoring and detecting a change in the asthma status, according to embodiments of the disclosure. At 400, the method includes sensing at least one parameter, where the parameter can be one or more of predictive of an asthma exacerbation event and useful in determining an increased risk of an asthma exacerbation event for a patient. The method continues at 402 with the step of determining a change in the asthma status of a patient by at least one of predicting the asthma exacerbation event and determining the increased risk of the asthma exacerbation event based on the at least one parameter.

Referring back to FIG. 5 at 302, if the status unit determines that no change in the asthma status of the patient has taken place, processing continues at 300 with monitoring the patient and the environment. If the status unit has detected a change in the asthma status, processing continues at 304.

At 304, the status unit identifies whether or not the change in the asthma status indicates a severe event. If the change in the asthma status does not indicate a severe event, the patient is alerted to the change in asthma status at 306 and processing continues at 300 with monitoring the patient and the environment. If the change in the asthma status indicates a severe event, processing continues at 308, with determining whether the patient has received a maximum dosage of one or more available drugs. In some embodiments, a severe event includes the prediction of an asthma exacerbation event within the next three days. In some embodiments, a non-severe event includes determining an increased risk of an asthma exacerbation event within the next 30 days. In other embodiments, a severe event can be otherwise defined to include forms of increased risk of having an asthma exacerbation event and/or a non-severe event can be otherwise defined to include forms of an acute onset asthma exacerbation event.

In one example, if the status unit determines that the patient is at an increased risk of an asthma exacerbation event, such as by determining that the patient is at an increased risk of an asthma exacerbation event within the next 30 days, the status unit alerts the patient to the increased risk, at 306, and continues processing at 300 with monitoring the patient and the environment. In embodiments, the status unit transmits the change in the asthma status to an external device, such as the external device 44 (shown in FIG. 2) or the external device 104 (shown in FIG. 3), and the external device alerts the patient to the change in the asthma status via its alarm and displays that the patient is at an increased risk of an asthma exacerbation event on the display of the external device. In some embodiments, the external device displays the reason or reasons for the increased risk determination, such as due to high air contaminants.

At 308, the status unit and/or the external device determine whether the patient has already received a maximum dose of an available drug. At 310, if the patient has already received the maximum dosage of a drug, the status unit and/or the external device alerts the patient and/or the health care provider to the dosage information. After receiving the maximum dose information, the patient and/or the health care provider can decide whether to administer more of the same drug or another drug. In some embodiments, the external device alerts the patient via its alarm and displays the maximum dosage information to the patient via its display. In some embodiments, the external device contacts the health care provider by a remote communications device, such as the remote communications device 64 (shown in FIG. 2) or the remote communications device 122 (shown in FIG. 3).

At 312, if the patient has not received the maximum dosage of an available drug, the status unit alerts the patient and directs a therapy unit, such as the therapy unit 206 (shown in FIG. 4), to administer a known amount of a drug to the patient. In embodiments, the therapy unit is configured to release a rescue drug to prevent or reduce the severity of an asthma exacerbation event, such as an acute onset asthma exacerbation event. In some embodiments, the increased risk of having an asthma exacerbation event is considered to be a severe event and the therapy unit is configured to release a management drug to reduce the increased risk of having the asthma exacerbation event.

In some embodiments, the therapy unit receives information from the status unit and in response to this information the therapy unit automatically provides the drug therapy to the patient. In some embodiments, the therapy unit automatically provides therapy to the patient by directing the drug delivery unit to administer a drug, such as epinephrine or methylprednisolone, to the patient to treat the declared event.

In some embodiments, the status unit alerts the patient and/or a health care provider prior to administering the drug. The status unit waits for consent or permission before directing the therapy unit to administer the drug. For example, the status unit alerts the patient via an alarm and displays the information on a display and/or the status unit sends a message via a remote communications device to the health care provider. The patient and/or the health care provider respond to the information by giving or withholding consent to provide the drug therapy. If consent is given, the status unit directs the therapy unit to provide the drug therapy, where the therapy unit directs the drug delivery unit to administer the drug, such as epinephrine or methylprednisolone, to the patient to treat the declared event. In some embodiments, the patient and/or the health care provider can prescribe a certain dosage and/or a certain kind of medication, such that the dose is delivered per patient or health care provider prescription.

After administering the drug at 312, processing continues with monitoring the patient and the environment at 300. The system can be configured to provide multiple doses and/or multiple drugs by repeating the above process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A system, comprising:
a sensor configured to ambulatorily sense a parameter that is one or more of predictive of an asthma exacerbation event and useful in determining an increased risk of an asthma exacerbation event for a patient; and
a status unit configured to determine a change in asthma status of the patient by at least one of predicting the asthma exacerbation event and determining the increased risk of the asthma exacerbation event based on the parameter.

2. The system of claim 1, wherein the sensor has been implanted in the patient to ambulatorily sense the parameter.

3. The system of claim 1, comprising an implantable device, wherein the sensor is situated in the implantable device.

4. The system of claim 3, wherein the status unit is situated in the implantable device.

5. The system of claim 1, comprising an external device, wherein the status unit is situated in the external device.

6. The system of claim 1, comprising an external device configured to provide at least one of a display and an alarm to provide information about the change in the asthma status.

7. The system of claim 1, comprising a therapy unit configured to provide asthma therapy to the patient in response to the change in the asthma status of the patient.

8. The system of claim 7, wherein the therapy unit includes a drug delivery unit that has been implanted in the patient and is configured to provide drug therapy to the patient by at least one of automatically responding to the change of the asthma status and providing the drug therapy in response to direction from one or more of the patient and a health care provider.

9. The system of claim 1, wherein the sensor is configured to sense at least one physiological parameter of the patient.

10. The system of claim 1, wherein the status unit is configured to determine the change in the asthma status of the patient by at least one of predicting that the asthma exacerbation event will occur within 3 days and determining the increased risk of the asthma exacerbation event up to 30 days prior to the asthma exacerbation event.

11. A system, comprising:
at least one sensor that has been implanted in a patient to ambulatorily sense at least one physiological parameter of the patient; and
a status unit to determine a change in asthma status of the patient based on at least one of predicting an asthma exacerbation event based on the at least one physiological parameter and determining an increased risk of the asthma exacerbation event based on the at least one physiological parameter.

12. The system of claim 11, wherein the at least one sensor includes at least one of a respiration sensor, a sound sensor, a heart rate sensor, an oxygen sensor, a muscle use sensor, an activity sensor, a posture sensor, an inflammation sensor, and a thoracic composition sensor.

13. The system of claim 11, wherein the at least one sensor includes a respiration sensor that is used to determine at least one of tidal volume, respiration rate, peak expiratory flow, forced expiratory volume, and a composite respiration index that includes at least one of an inspiration/expiration ratio, tidal volume times respiration rate, and respiration rate divided by tidal volume.

14. The system of claim 11, wherein the at least one sensor includes a sound sensor that includes at least one of a lung sound sensor, a speech sensor, and a heart sound sensor, wherein the lung sound sensor is configured to sense wheezing in the patient.

15. The system of claim 11, wherein the increased risk of the asthma exacerbation event is determined based on at least one of environmental data, patient activity, patient sleep quality, patient physical stress, patient mental stress, menstrual cycle, time-of-day, and patient posture, wherein the environmental data includes at least one of air temperature, air contaminants, humidity, altitude, and air pressure.

16. A method comprising:
sensing, ambulatorily, at least one parameter that is one or more of predictive of an asthma exacerbation event and useful in determining an increased risk of an asthma exacerbation event for a patient; and
determining a change in asthma status of the patient by at least one of predicting the asthma exacerbation event and determining the increased risk of the asthma exacerbation event based on the at least one parameter.

17. The method of claim 16, comprising at least one of:
creating an alert based on the change in the asthma status; and
releasing a drug to provide drug therapy in response to the change in the asthma status.

18. The method of claim 17, wherein releasing a drug includes at least one of releasing a rescue drug to prevent or reduce the severity of the asthma exacerbation event and releasing a management drug to reduce the risk of having an asthma exacerbation event.

19. The method of claim 17, wherein releasing a drug includes one or more of automatically releasing the drug in response to the change in the asthma status and releasing the drug after receiving permission from one or more of the patient and a health care provider.

20. The method of claim 16, comprising:
determining if a maximum dosage of the drug has been provided to the patient and, if it has, providing at least one of alerting the patient and contacting a health care provider that the maximum dosage has already been provided to the patient.
